(19) United States
(12) Patent Application Publication
(10) Pub. No.: US 2014/0075364 A1
(43) Pub. Date: Mar. 13, 2014

(54) Capturing Activity History Stream

(71) Applicants: Andrew C. Bragdon, Redmond, WA (US); Gareth A. Jones, Issaquah, WA (US); Mark Groves, Monroe, WA (US); Tracey Trewin, Redmond, WA (US)

(72) Inventors: Andrew C. Bragdon, Redmond, WA (US); Gareth A. Jones, Issaquah, WA (US); Mark Groves, Monroe, WA (US); Tracey Trewin, Redmond, WA (US)

(73) Assignee: MICROSOFT CORPORATION, Redmond, WA (US)

(21) Appl. No.: 13/613,533

(22) Filed: Sep. 13, 2012

(51) Int. Cl. G06F 3/048

(52) U.S. Cl. 715/772

(57) ABSTRACT

A code stream provides a historical view of changes to program code and related actions. The code stream is displayed concurrently with the code for reference, navigation, editing, sharing, and to aid in interruption recovery. The code stream automatically constructs a list of visited code segments based on user changes to the code or navigation within the code. The code stream is an activity history that is constructed based on analysis of user navigation behavior, such as specific edits to the code or dwelling in a section of the code. The user has the ability to undo changes in the code in a non-linear fashion by individually reversing changes from the history listed in the code stream. The user may manually add other non-code items to the code stream.

### BACKGROUND

Developers frequently navigate to the same sections of code in projects in an integrated development environment (IDE). These sections may be continuously edited as the developers refine key features, for example. Users must move between files and scroll through lines of code to find the functions of interest or to review previous edits. For large projects with multiple code files and very many lines of code, it can be time consuming for users to move among a few frequently visited sections of code.

When the user returns to a previously edited section of code, they must recall from memory or refer to notes to remember what changes were previously made in that code section. For a much revised section of code and for very large projects, it can be difficult for users to keep track of all the changes that were previously entered.

Similar problems arise in word processing, project management, database, and other programs. Certain sections of large document collections, projects, or databases may be visited and edited more frequently than others, but these often-visited sections may be spread out among the relevant files.

Previous solutions allow users to use a search tool to find selected sections of a file or document. However, the search must be run each time to create a list of possible destinations. Additionally, the searches do not include information regarding past edits to the code or text. Some applications provide a simple list of previous edit actions that indicate, for example, the occurrence of deletions, insertions, moves, font changes, and the like. However, these lists do not show a chronological list of the user's edits or the user's navigation within the document or file.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A user's repeated navigations within a code file or text document may be predicted based on the user's prior navigations. Users are more likely to return to functions or methods they have edited in the past or in which they have spent a significant amount of time but not editing (i.e., dwelling). In one embodiment, a code stream provides a historical view of the user's changes to program code and related actions. The user can display the code stream view on the screen concurrently with the code for reference, navigation, editing, sharing, and to aid in interruption recovery.

The code stream automatically constructs a list of visited code segments based on user changes to the code or navigation within the code. The code stream is an activity history that is constructed based on analysis of user navigation behavior, such as specific edits to the code or dwelling in a section of the code. The user has the ability to undo changes in the code in a non-linear fashion by individually reversing changes from the history listed in the code stream.

The code stream can be saved, persisted to a file and shared with other users. The code stream integrates with a suspend/resume mechanism to help resume tasks more efficiently because the code stream allows a user to see what happened with the task prior to its suspension. The code stream includes a deep provenance of the code by saving the location and differences in previous versions of the code. Changes to the same function are grouped into one history point in the code stream.

Additionally, users can explicitly include or exclude individual items in the code stream view. External information, such as tasks, emails, instant messages, web pages, debug data, variable values, and the like, can be tagged into the code stream.

In other embodiments, the code stream may represent content of documents, projects, databases or other files.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is an example display for an integrated development environment that provides a code stream for the user.

FIGS. 2-5 are example displays showing changes to the code stream as the user edits the code.

FIG. 6 illustrates the effect of navigation in the code window by selecting an item in the code stream.

FIG. 7 is a flowchart illustrating a method or process for tracking user activity within an application.

FIG. 8 is a flowchart illustrating a method or process for tracking user activity within an integrated development environment.

FIG. 9 illustrates an example of a suitable computing and networking environment.

### DETAILED DESCRIPTION

A code stream is automatically constructed based on user behavior while viewing, creating, or editing code in a file. User activity is monitored and a degree-of-interest model is created to determine the set of content that is most relevant to the user. For example, when a user creates new code, edits existing code, or spends time looking (i.e., dwells) at specific code, that code is identified as being of higher interest to the user. It is more likely that the user will return to this code for additional revisions or reference compared to other code.

Users may further extend the code stream by manually tagging content into the code stream. These items may include code (e.g., functions, methods, etc.) that has not been automatically added to the code stream or external material, such as tasks, emails, instant messages, debug data, and the like.

The user may also tag external information into the code stream through an extensible provenance framework. For example, in one embodiment, a textual representation cache is saved for each code stream item along with a cache timestamp, as well as a history tag type, a timestamp, and an XML blob comprising the location of the information. A plug-in architecture allows this information to be resolved and displayed on the screen.

The code stream typically presents a historical view showing the most recently accessed code at the top of a list. The user can select specific items in the code stream to undo. The user is not required to undo later edits in order to undo the selected code. This allows the user to undo their changes in a non-linear manner.

The code stream can be saved and persisted to a file. This allows the code stream to be shared with other users or to be recalled by the user at later time. The persistence file contains complete details of the code stream, such as the fully-qualified name of the methods/functions/classes, the start/end locations (offsets) in the file, the fully qualified path to the file, as well as the actual contents of the fragment. Additionally, a baseline version of the file and branch information may be stored. A fully qualified version control path may also be stored. This allows the code stream to reliably re-open on other computers. If the user does not have the content, then a static cache of the contents may be shown. If the user has the wrong version of the code files, a warning regarding version error may be shown and the cached content is shown. Otherwise, the actual live file content is shown if available. The redundant information comprises deep provenance.

The code stream allows for suspend/resume integration, which allows the user to suspend their work and resume it later. The code stream allows users to resume the task more efficiently by reading the available history information.

Code changes are displayed in the code stream in chronological order with relative timestamp information for each entry. The system groups multiple edits in the same function into a single entry, showing this entry at the timestamp of the most recent edit in that function. For non-functional edits, the system displays just the edited lines and provenance information.

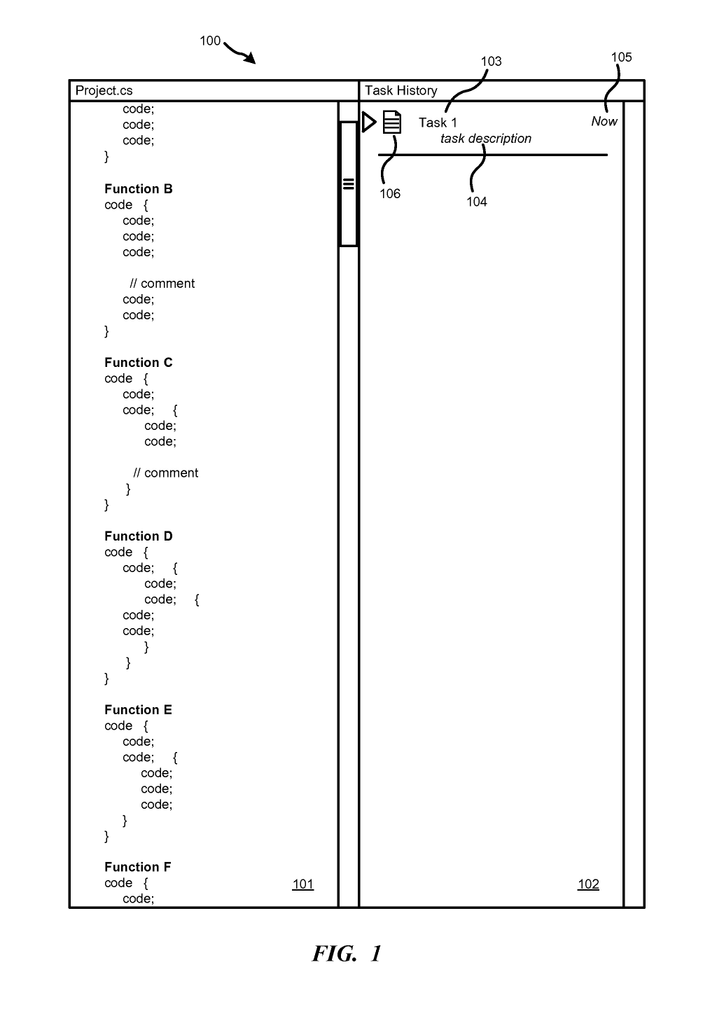

FIG. 1 illustrates an example display 100 for an IDE that provides a code stream for the user. Editor window 101 displays code for a selected project. Editor window 101 displays generic code that represents any function, method, object, class or other code structure that is appropriate for a selected programming language. Task history window 102 includes the activity items in the user's code stream. In this example, the user has activated a work item—Task 1 (103)—which is added to the code stream in task history window 102. A task description 104 or other information may be included with Task 1 as well as a timestamp 105. The content of task description 104 may be user-entered content or may be a default value, such as the title of the task. Task description 104 may display a default amount of text, such as one or more lines, or any amount of text selected by the user. Timestamp 105 may represent a specific time (i.e., “1:15 PM”) when the task was opened or completed or an elapsed time (i.e., “1 hour ago”) since the action was open or completed. Alternatively, timestamp 105 may show both the start and completion times and/or a duration the user worked on that task. Task icon 106 may indicate that the task has been started, completed, or shared or may represent an author or owner of the task.

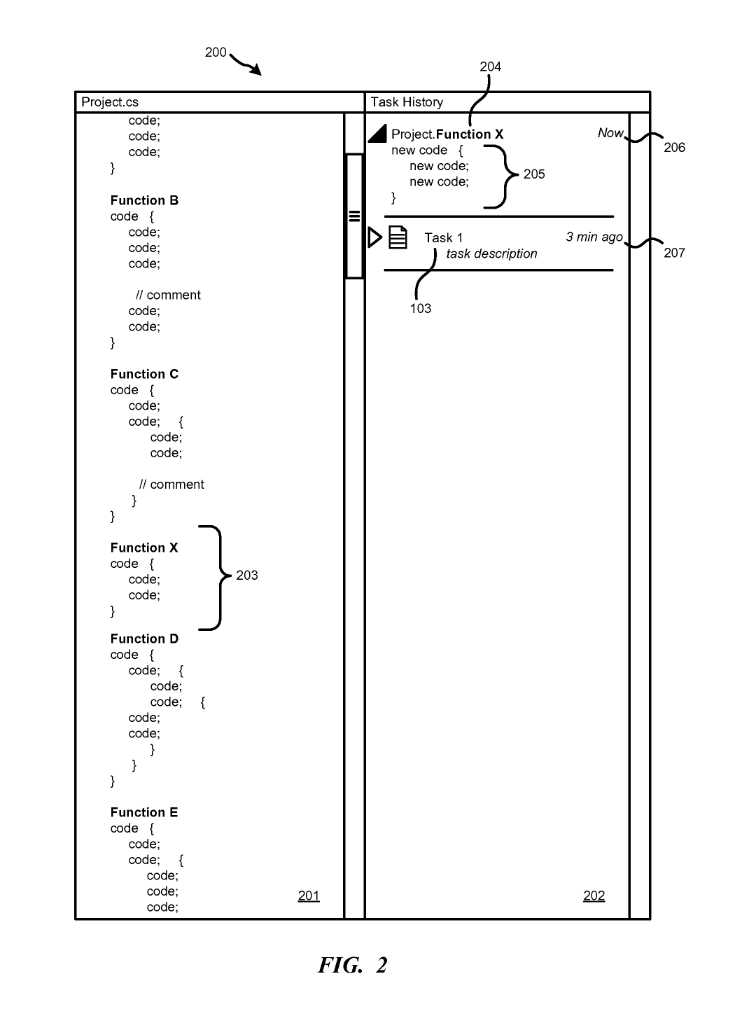

FIG. 2 illustrates an example display 200 after the user has edited the code. Display 200 shows the updated code 201 and a new code stream 202. As illustrated in editor window 201, the user has added new code, such as new Function X 203, to the project. The new code is also added to task history window 202 and is identified by the edited function—Function X (204). The new code 205 for this function is also shown in the task history 202. The font or highlighting used for new code 205 may be selected to indicate how it was edited or added. For example, inserted code may be underlined, deleted code may be shown as strikeout text and moved or copied code may be highlighted in some other way. A timestamp 206 is also applied to this new task. The timestamp 207 for the previous code stream entry—Task 1 (103)—has also been updated when the new task was added.

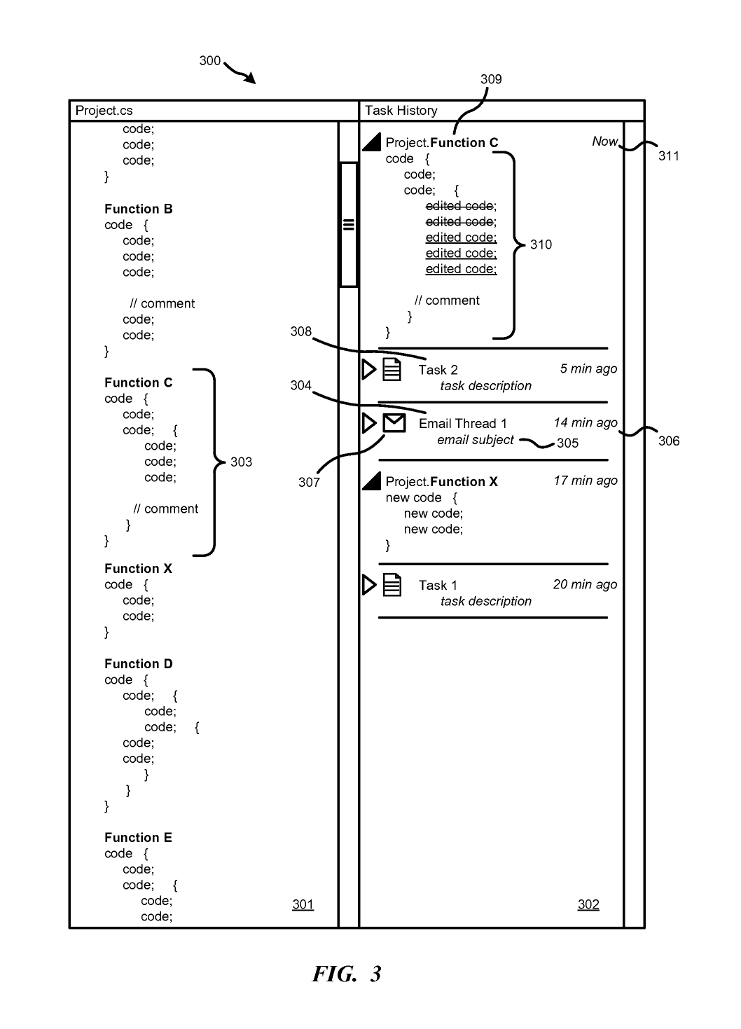

FIG. 3 illustrates an example display 300 after the user has further edited the code. Editor window 301 and task history window 302 illustrate these edits and reflect other user actions. In particular, the user has edited Function C (303) and started a new task, Task 2. After editing Function X (204), the user accessed an email thread. Email Thread 304 may be manually added to the code stream in task history window 302 by the user or may be automatically added if, for example, the email is linked to this project. Email text 305 may include, for example, a subject line, sender name, or some or all of the email content. Timestamp 306 notes the time that the email was added, read, or created. Envelope icon 307 may indicate whether the user wrote, read, replied, forwarded or otherwise processed the email thread.

The user has also opened another task 308, which is added to the code stream timeline with the appropriate description and timestamp.

The user's edits to Function C 309 have also been added to the code stream timeline. In particular, Function C originally had five lines of code and has now been edited to have six lines of code. The new code is shown in editor window 301. Entry 309 in task history 302 also shows the changes 310 to the code. The edited code 310 for Function C may be assigned a font or highlighting that indicates how it was edited by the user. For example, inserted code may be underlined, deleted code may be shown as strikeout text and moved or copied code may be highlighted in some other way. A timestamp 311 is also applied to this new task and the timestamps for the previous entries have been updated.

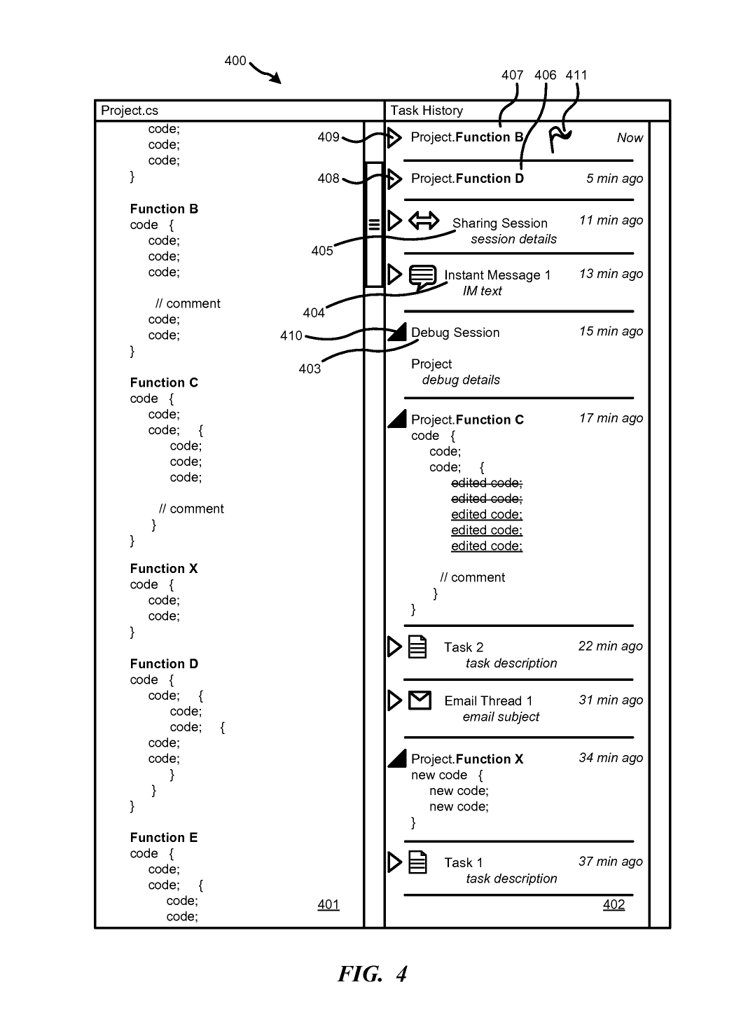

FIG. 4 illustrates another example display 400 after the user has further edited the code. Again, editor window 401 and task history window 402 illustrate these edits and reflect other user actions. Following the edits to Function C (309), the user began a debug session. Debug Session 403 was added to the task history along with debug details and a time stamp. The debug details may include any content added by the user or automatically generated by the IDE to document the debug session.

An Instant Message 404 and Sharing Session 405 have also been added to the code stream along with relevant details and timestamps. These entries may have been added manually by the user or automatically added by the IDE.

The task history 402 also shows that the user has dwelled in two functions—Function D (406) and Function E (407). Dwelling may include, for example, opening or selecting the function in the editor window 401, copying the function or lines of code, making unsaved edits in the function, or otherwise indicating a user interest in the function. The icons 408, 409 indicate that other details are available for dwelling entries 406 and 407, but the details are collapsed out of view to simplify the display. On the other hand, icon 410 for Function C (309) may indicate that this entry has been expanded to show the relevant details. The user has flagged (411) the entry for Function B (407), which may be used, for example, to indicate that the user should return to this function or to highlight the function to a co-worker.

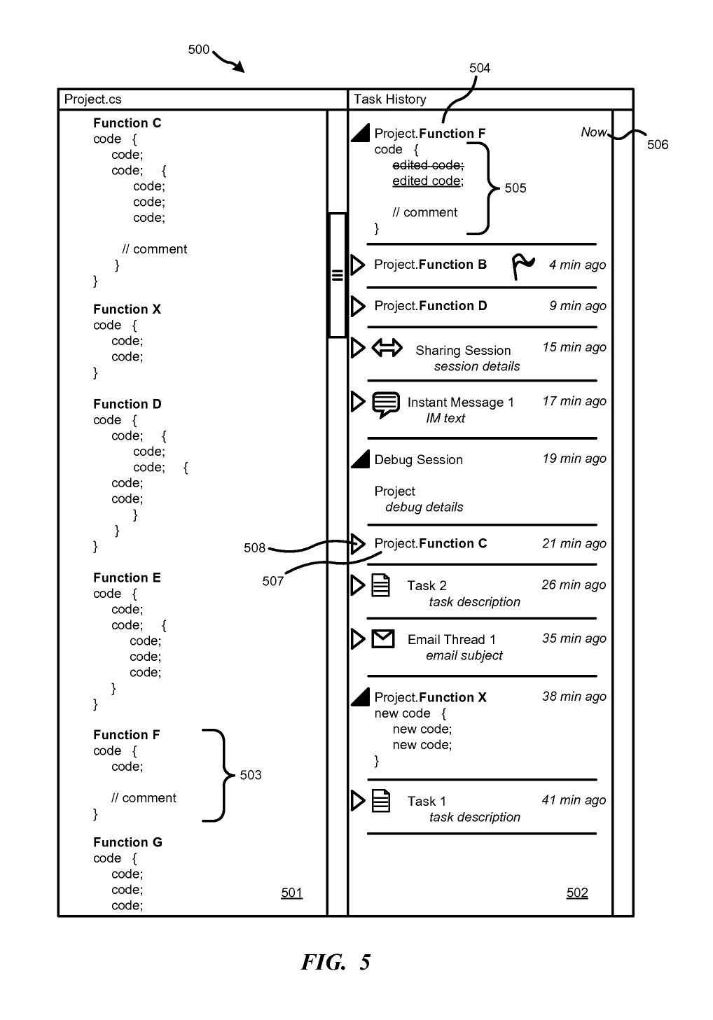

FIG. 5 illustrates another example display 500 after the user has edited another function—Function F (503)—in editor window 501. Corresponding entry 504 has been added to the task history window 502 along with the relevant edits 505 and timestamp 506. The timestamps for the other entries in the task history have been updated, and the details for the edits to Function C (507) have been collapsed by the user—as indicated by icon 508—to simplify the display.

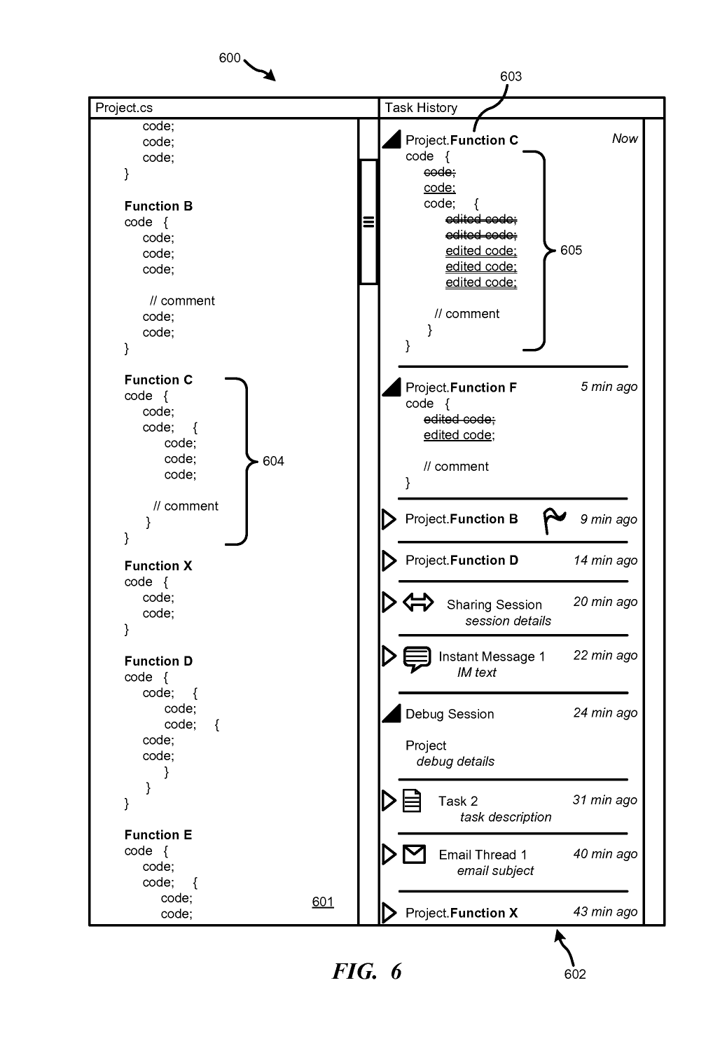

FIG. 6 illustrates the display 600 after the user has selected an existing item from the code stream in the task history window 602. The user has selected Function C (603) from the task history window 602, which moves this entry to the top of the code stream and makes it the current entry. Also, the editor window 601 moves to the selected Function C (604). The user has further edited the code in Function C. These edits 605 are shown in the task history. In the illustrated example, current edits are shown by single underlining and single strikeout text and previous edits (e.g., the earlier edits from FIG. 4) are shown using double underlining and double strikeout text. In other embodiments, different types of fonts and/or highlighting may be used to indicate edits to the code. Alternatively, the task history 602 may only indicate current edits, and the user may have the capability to selectively display and/or step through displays of previous edits, if any.

The previous entry for Function C was listed between the Debug Session and Task 2 entries in task history window 602. This entry has been removed because Function C is now the current activity at the top of the list. In other embodiments, the previous entries for the same function or task may remain in their original position to display a task-by-task list of the user's previous activity in the project.

Although the example shown in FIGS. 1-6 illustrates an IDE that is used to work with code, it will be understood that the activity history stream may be used with other applications, such as word processing, document management, project management, database, and other applications. The user's activity in such applications can be tracked and displayed in a manner similar to the task history illustrated above. Additionally, the activity history may correspond to multiple files and/or applications where the user has several different programs open at the same time and is moving among the programs.

The user's activity history, such as the code stream shown in the task history windows of FIGS. 1-6, may be saved either with or separately from the corresponding code, document, project, or other file to which it is associated. The activity history may be shared among users working on the same project. This would allow a new user to quickly identify what edits were made and which task were completed by the prior user.

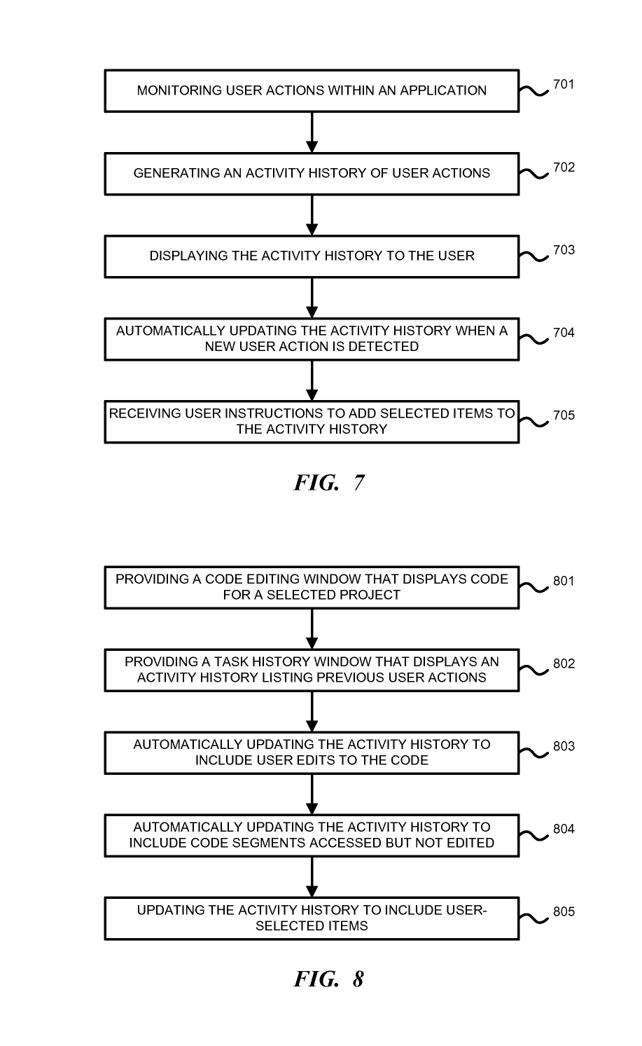

FIG. 7 is a flowchart illustrating a method or process for tracking user activity within an application. In step 701, user actions within an application are monitored. The application may be an integrated development environment and the user actions comprise edits to software code. In step 702, an activity history of the user actions is generated. The activity history may comprise a chronological list of the user actions. In step 703, the activity history is displayed to the user. In step 704, the activity history is automatically updated when a new user action is detected.

In step 705, user instructions are received indicating selected items to add to the activity history. These user-selected are added to the activity history and displayed to the user. The selected items may be associated with other applications running on the same or a different computer. The selected items may be tasks, email messages, instant messages, web pages, and debugger variable values.

When a user selection of an item listed in the activity history is received, the content related to the user-selected item is displayed. The user-selected item may be, for example, a previous edit to the software code. The activity history may be saved in a format that can be accessed by another user.

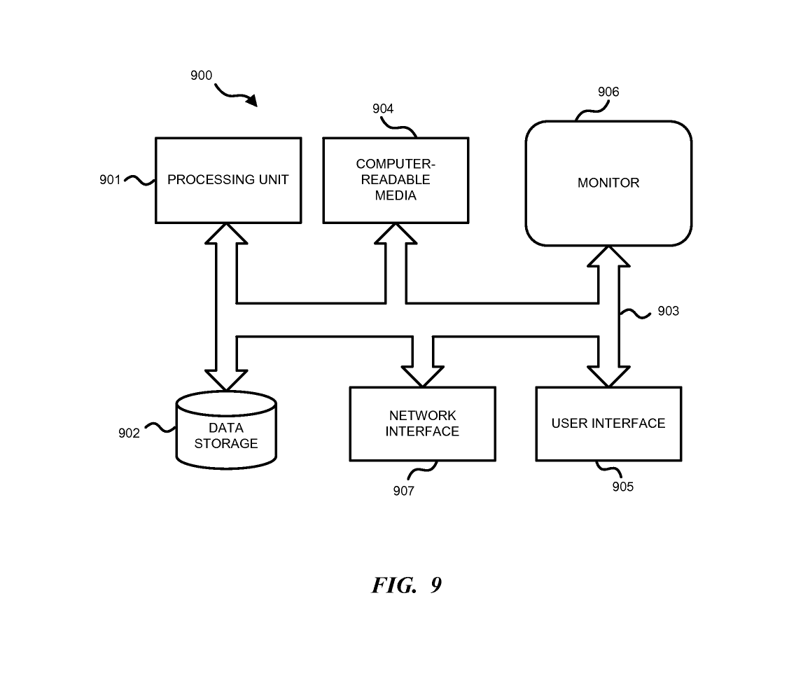

FIG. 8 is a flowchart illustrating a method or process for tracking user activity within an integrated development environment. In step 801, a code editing window is provided to display code for a selected project. In step 802, a task history window is provided to display an activity history that lists previous user actions associated with the code. In step 803, the activity history is automatically update to include user edits to the code. In step 804, the activity history is automatically updated to include code segments that have been accessed by the user but not edited. In step 805, the activity history is updated to include user-selected items, such as tasks, email messages, instant messages, web pages, and debugger variable values.

The activity history may also be updated to remove user-selected items. A user may identify a previous action in the activity history and designate that previous action to be reversed. The previous action may be an edit to the code that occurred at a designated time. The code is returned to a prior state that existed at the designated time without undoing other code edits that occurred at other times.

The activity history may be saved in a sharable format that can be accessed by other users to determine what actions were performed on the code.

It will be understood that steps 701-705 of the process illustrated in FIG. 7 and steps 801-805 of the process illustrated in FIG. 8 may be executed simultaneously and/or sequentially. It will be further understood that each step may be performed in any order and may be performed once or repetitiously.

FIG. 9 illustrates an example of a suitable computing and networking environment 900 on which the examples of FIGS. 1-8 may be implemented. The computing system environment 900 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an exemplary system for implementing various aspects of the invention may include a general purpose computing device in the form of a computer 900. Components may include, but are not limited to, various hardware components, such as processing unit 901, data storage 902, such as a system memory, and system bus 903 that couples various system components including the data storage 902 to the processing unit 901. The system bus 903 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 900 typically includes a variety of computer-readable media 904. Computer-readable media 904 may be any available media that can be accessed by the computer 900 and includes both volatile and nonvolatile media, and removable and non-removable media, but excludes propagated signals. By way of example, and not limitation, computer-readable media 904 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 900. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory 902 includes computer storage media in the form of volatile and/or nonvolatile memory such as read only memory (ROM) and random access memory (RAM). A basic input/output system (BIOS), containing the basic routines that help to transfer information between elements within computer 900, such as during start-up, is typically stored in ROM. RAM typically contains data and/or program modules that are immediately accessible to and/or presently being operated on by processing unit 901. By way of example, and not limitation, data storage 902 holds an operating system, application programs, and other program modules and program data.

Data storage 902 may also include other removable/non-removable, volatile/nonvolatile computer storage media. By way of example only, data storage 902 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 9, provide storage of computer-readable instructions, data structures, program modules and other data for the computer 900.

A user may enter commands and information through a user interface 905 or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit 901 through a user input interface 905 that is coupled to the system bus 903, but may be connected by other interface and bus structures, such as a parallel port, game port or a universal serial bus (USB). A monitor 906 or other type of display device is also connected to the system bus 903 via an interface, such as a video interface. The monitor 906 may also be integrated with a touch-screen panel or the like. Note that the monitor and/or touch screen panel can be physically coupled to a housing in which the computing device 900 is incorporated, such as in a tablet-type personal computer. In addition, computers such as the computing device 900 may also include other peripheral output devices such as speakers and printer, which may be connected through an output peripheral interface or the like.

The computer 900 may operate in a networked or cloud-computing environment using logical connections 907 to one or more remote devices, such as a remote computer. The remote computer may be a personal computer, a server, a router, a network PC, a peer device or other common network node, and typically includes many or all of the elements described above relative to the computer 900. The logical connections depicted in FIG. 9 include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer 900 may be connected to a public or private network through a network interface or adapter 907. In some embodiments, a modem or other means for establishing communications over the network. The modem, which may be internal or external, may be connected to the system bus 903 via the network interface 907 or other appropriate mechanism. A wireless networking component such as comprising an interface and antenna may be coupled through a suitable device such as an access point or peer computer to a network. In a networked environment, program modules depicted relative to the computer 900, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
monitoring user actions within an application running on the computer;
generating an activity history of the user actions, the activity history comprising a chronological list of the user actions;
displaying the activity history to the user; and
automatically updating the activity history when a new user action is detected.

2. The computer-implemented method of claim 1, further comprising:
receiving user instructions to add selected items to the activity history; and
displaying the selected items in the activity history.

3. The computer-implemented method of claim 2, wherein the selected items are associated with other applications running on the computer.

4. The computer-implemented method of claim 1, wherein the application is an integrated development environment and the user actions comprise edits to software code.

5. The computer-implemented method of claim 1, further comprising:
adding user-selected items as additional entries to the activity history, wherein the additional entries indicate user interaction with the items and allow navigation to associated content when selected by the user.

6. The computer-implemented method of claim 5, further comprising:
receiving a user selection of an item listed in the activity history; and
displaying content related to the user-selected item.

7. The computer-implemented method of claim 6, wherein the user-selected item is previous edit to the software code, and further comprising:
identifying a section of the software code that is associated with the previous edit; and
displaying the section of the software code to the user.

8. The computer-implemented method of claim 1, further comprising:
saving the activity history in a format that can be accessed by another user.

9. A computer-readable storage medium storing computer-executable instructions that, when executed by a processor, perform a method for providing an integrated development environment to users, the method comprising:
providing a code editing window that displays code for a selected project; and
providing a task history window displaying an activity history that lists previous user actions associated with the code.

10. The computer-readable storage medium of claim 9, wherein the method further comprises:
automatically updating the activity history to include user edits to the code.

11. The computer-readable storage medium of claim 9, wherein the method further comprises:
automatically updating the activity history to include code segments that have been accessed by the user but not edited.

12. The computer-readable storage medium of claim 9, wherein the method further comprises:
updating the activity history to include user-selected items.

13. The computer-readable storage medium of claim 9, wherein the method further comprises:
adding user-selected items as additional entries to the activity history, wherein the additional entries indicate user interaction with the items and allow navigation to associated content when selected by the user.

14. The computer-readable storage medium of claim 9, wherein the method further comprises:
updating the activity history to remove user-selected items.

15. The computer-readable storage medium of claim 9, wherein the method further comprises:
receiving a user identification of a previous action in the activity history; and
reversing the previous action.

16. The computer-readable storage medium of claim 15, wherein the previous action comprises an edit to the code that occurred at a designated time, and wherein reversing the previous action comprises:
returning the code to prior state that existed at the designated time without undoing other code edits that occurred at other times.

17. The computer-readable storage medium of claim 9, wherein the method further comprises:
saving the activity history in a sharable format that can be accessed by other users to determine what actions were performed on the code.

18. In a computing environment where resources are distributed, a method of tracking user activity on resources distributed in the computing environment, the method comprising:
providing a user activity window displaying a document to a user;
providing a task history window displaying an activity history listing previous user actions within the document; and
automatically updating the activity history to include new user actions.

19. The method of claim 18, further comprising:
updating the activity history to include user-selected items.

20. The method of claim 18, further comprising:
receiving a user identification of a previous action in the activity history; and
reversing the previous action without undoing other actions that occurred after the previous action.
